(19) United States
(12) Patent Application Publication
(10) Pub. No.: US 2013/0084541 A1
(43) Pub. Date: Apr. 4, 2013

(54) IMPLANT SYSTEM

(71) Applicant: Marcus von Malottki, Erkrath (DE)

(72) Inventor: Marcus von Malottki, Erkrath (DE)

(73) Assignee: SIC INVENT AG, Basel (CH)

(21) Appl. No.: 13/593,887

(22) Filed: Aug. 24, 2012

(30) Foreign Application Priority Data
Aug. 26, 2011 (EP) 11006976.2-1269

(51) Int. Cl. A61C 8/00

(52) U.S. Cl. CPC A61C 8/0025
USPC 433/174

(57) ABSTRACT

An implant system (160) for fastening a blocked, detachable dental prosthesis (172) in a patient's jaw (166), comprising at least one distal implant (130) and at least one mesial implant (2), wherein each implant (2, 130) comprises a screw-in part (8) with an external thread (14), an abutment (20, 136) which can be inserted into the screw-in part (8), and a functional part (26) for fastening the dental prosthesis (172), which can be screwed together with the abutment (20, 136) by means of a functional screw (32), shall improve the anchorage of a blocked dental prosthesis (172) in a jaw (166) as against conventional solutions. For this purpose, according to the invention, the abutment (20) of each mesial implant (2) is made up of several parts, in particular of two parts.

The invention relates to an implant system for fastening a blocked, detachable dental prosthesis in a patient's jaw, comprising at least one distal implant and at least one mesial implant, wherein each implant comprises a screw-in part with an external thread, an abutment which can be inserted into the screw-in part, and a functional part for receiving the dental prosthesis, which can be screwed together with the abutment by means of a functional screw. It also relates to an implant suitable therefor. For the purpose of this application, the term “implant” refers to the entity consisting of the functional part, the abutment or assembly part, and the screw-in part, whereas usually, the term “implant” refers to the screw-in part only.

Such implant systems are particularly well suited for supplying a patient on a short-term basis with a dental prosthesis in the form of, for example, screwed bridges. If a patient is to receive, for example, a bridge substantially comprising the entire range of visible teeth in the lower jaw, usually two mesial implants are used in the area of the front incisors and two distal implants, in the rear area of the jaw. An abutment and a functional part fastened thereon for receiving the dental prosthesis are assigned to each implant. This dental prosthesis can be placed, screwed and detached again by a dental technician. Nowadays, such an implant system can be seated in the patient's jaw and the patient can be treated with a corresponding dental prosthesis within a few days, so that the patient does not need to stay without his own teeth and, at the same time, without a dental prosthesis, for several weeks or even months.

Known solutions of such implant systems usually include abutments or assembly parts which are screwed directly into the screw-in part, and these abutments then receive the functional parts. The bridges and prosthesis components fastened with such implant systems may extend from the front area of the jaw on both sides up to the rear area of the molar teeth. Due to this far extension of the dental prosthesis or denture in the jaw, the prosthesis is exposed during the patient's chewing and biting processes to loads varying both in strength and in direction or orientation.

The invention is based on the problem to provide an implant system of the above-mentioned type, in which the anchorage of a blocked dental prosthesis in a jaw is improved as against conventional solutions. Furthermore, an implant suitable therefor shall be provided.

With regard to the implant system, this problem is solved according to the invention by making up the abutment of each mesial implant of several parts, in particular of two parts.

Advantageous embodiments of the invention are the subject matter of the dependent claims.

The invention starts out from the consideration that a prosthesis of large extension in the jaw, which is held by several implants, inclusive of its anchorage in the jaw via the implants, is exposed to high loads, especially in the front area of the jaw, because in this area, lateral shearing and tensile forces may occur, in addition to compressive and frictional forces. This is due to the fact that the dental prosthesis or the bridge may extend from the front area of the jaw over the distal implants and even beyond the area of the (former) molar teeth. Corresponding chewing movements may cause tilting movemention of the prosthesis about an imaginary axis substantially running through the distal implants. Furthermore, shifts of the dental prosthesis as a whole may occur, leading to shearing forces.

To guarantee a permanent hold of the prosthesis in the jaw, with as little material wear and as low a risk of breakage or failure as possible, the forces arising in the front area of the jaw should be compensated as far as possible by the construction of the implant system or the implants located there. With a single-piece abutment, which is screwed into the screw-in part and can only absorb or compensate forces in the area of the screw connection, this is possible to an insufficient degree only.

It has now been found out that this problem can be solved by making up the abutment of the respective mesial implant, i.e. of the implant inserted into the bone in a straight line and substantially perpendicularly to the bone, of several parts, in particular, of two parts. By using several components interlocking each other, interfaces between these components can be created, which are particularly well suited for absorbing or compensating the forces arising in this area. Especially a two-piece embodiment of the abutment or assembly part is an optimized compromise between the number of components used and the functionality achievable through this subdivision. With the implant system provided, an implant-based screwable supraconstruction is realized, in which the corresponding prosthetic components can be screwed together in an occlusal manner.

In a preferred embodiment, the abutment of the mesial implant is made up of two parts, namely an insertion part which can be inserted into the screw-in part and a screw-in pillar which can be inserted into the insertion part.

The insertion part advantageously includes in an apical area an external connection piece which is received by an inner area the screw-in part, to form a form-locking rotation-safe and torsion-safe connection. In a particularly advantageous embodiment, the external connection piece is configured as an external hexagon, which is received in a form-locking manner by an inner area of the screw-in part configured as an internal hexagon. In this way, a torsion-safe connection of the abutment or its insertion part, respectively, and the screw-in part is created, through which a loosening or wearing of the connection between abutment and screw-in part is greatly reduced as compared with solutions in which abutment and screw-in part are substantially only screwed together. Instead of a hexagon, a lower or higher number of edges can be used. Square connections or connection pieces, such as fins, ribs or edges, received in corresponding slots in the screw-in part, are also imaginable.

For fastening and anchoring the abutment in the screw-in part of the implant, the screw-in part advantageously has an internal thread and the screw-in pillar, in an apical end area, a matching external thread, so that the screw-in pillar can be screwed into the screw-in part. That means that the screw-in pillar is then inserted into the insertion part inserted or plugged into the screw-in part and is then screwed, in its lower area facing towards the jaw, with its external thread into a matching internal thread of the screw-in part. In this way, the screw-in pillar, the insertion part and the screw-in part are firmly connected with each other. Contrary to known solutions, in which the abutment is made up of a single part in the mesial area and is directly screwed into the screw-in part, the two-piece configuration of the abutment with screw-in pillar and insertion part enables a more stable connection.

The screw-in pillar advantageously includes in a coronal head area a conically aligned attachment for receiving the functional part. The functional part having a corresponding internal cone can then be placed onto this conical attachment, which is, so to speak, in shape-congruent alignment, in a form-locking connection which is not clamp-locking and which is easy to detach or to disassemble. By means of such a form-locking conical connection, static frictional forces and also abrasive forces caused by a relative movement of the dental prosthesis between the mesial and distal areas, can be minimized. Furthermore, it is possible to compensate the axial divergences, which are usually inavoidable due to the same direction of insertion of a dental prosthesis and which often lie in the range of 5-10°. Then, the functional part is screwed together with the screw-in pillar in the latter's head area by means of a functional screw in a known manner. Thanks to the shape-adapted and detachable connection of the functional part with the abutment, the dental prosthesis can be screwed off and easily removed from the respective abutment at any moment.

In a preferred embodiment, a guide cylinder, in particular a guide cylinder with a conical bearing seat or a conical centering bearing face, follows an apical end of the head area, which guide cylinder is received, in the inserted condition, by the insertion part in a form-locking manner. By such a form-locking connection in the area of the cylinder between the insertion part and the screw-in pillar, lateral shearing forces can be compensated. That means that, contrary to solutions with a single-piece abutment, the solution described provides not only the screwed connection with the screw-in part, but also an additional form-locking connection for absorbing laterally acting forces. In this way, the shearing forces acting upon the screw-in pillar can be transmitted in a form-locking manner via the guide cylinder onto the insertion part and in a form-locking manner, from the insertion part via the hexagon onto the screw-in part, or can be distributed among these components. Through the conical centering bearing face, in which the guide cylinder preferably strongly tapers in apical direction, lateral forces as well as relative movements can be minimized. In addition, the bearing face of the screw-in pillar is centered on the insertion part.

For a further optimized force distribution, the aligned cone, in the screwed condition of the screw-in pillar and the screw-in part, advantageously rests on the insertion part.

To be able to screw the screw-in pillar into the screw-in part with a corresponding tool in a comfortable manner, the screw-in pillar advantageously includes an external hexagon at the outermost end of the head area. This external hexagon is designed such that it is, so to speak, worked out of the conical head area, so that the functional part can be pushed over the hexagon.

To keep the number of different components necessary for providing the implant system as low as possible, the functional parts of the respective distal and mesial implants are advantageously of identical configuration. Accordingly, the abutments of the distal implants, just like the multi-piece, in particular two-piece, abutments of the mesial implants, include a conically aligned attachment for receiving the respective functional part. In a further advantageous embodiment, the functional screws for screwing the functional parts together with the abutments of the distal and mesial implants are of identical configuration. The abutments of the distal implants are preferably of single-piece design, the respective abutment being screwed into the corresponding screw-in part by means of a screw.

Due to the anatomic conditions in the distal area of the jaw, for example smaller bone thickness or less vertical bone height, as compared with the front area of the jaw, the impossibility or waiver of bone-building measures, the limited bone offer in vertical direction and, in particular, the course of nerve pathways, the use of screw-in parts, like those applied in the front area of the jaw, must usually be refrained from in that place, as far as they are to be inserted into the jaw in a straight line or perpendicularly. Instead of reducing the length of the screw-in part, a screw-in part of approximately the same length is preferably inserted obliquely into the jaw in such cases, so that the length of the implant located in the jaw bone is substantially equal to the corresponding length of the implant inserted in the front area of the jaw in a straight line. The corresponding distal implant is in that case substantially inserted into the jaw in such a way that it extends obliquely from a rear area of the jaw towards the front in the direction of the front jaw.

To make it possible to fasten the dental prosthesis on these obliquely inserted implants by means of functional parts, in the manner in which it is possible with the mesial implants—i.e., the functional parts shall be oriented here substantially in parallel to the functional parts in the front jaw—the abutments of the respective distal implant are advantageously beveled by an angle between 20° and 40°, in particular of 22° or 35°.

In a preferred embodiment of the implant system, exactly two distal implants and two mesial implants are provided. By means of such a number of implants, bridges or dental prostheses spanning a wide area of the row of teeth can be placed in a stable manner and possibly symmetrically to the middle of the jaw. In another preferred embodiment, exactly two distal implants and exactly four mesial implants are provided. With such an arrangement, the dental prosthesis can be anchored in the front area of the jaw in a particularly firm manner.

If the corresponding dental prosthesis reaches far into the rear area of the jaw and/or the corresponding bone substance requires further fastenings or stabilizations, exactly four distal implants and two mesial implants are advantageously provided.

The above-described implant system can be applied, using exactly one mesial implant and exactly one distal implant, for anchoring a blocked dental prosthesis in a front lateral area of the upper or lower jaw. In this case, too, the forces resulting from chewing and biting movements can be transmitted into the bone in a manner sparing the material due to the indicated construction of the mesial implant.

With regard to the implant, the above-mentioned problem is solved according to the invention by making up the abutment of two parts, namely an insertion part which can be inserted into the screw-in part and a screw-in pillar which can be inserted into the insertion part. Advantageously. the insertion part includes in an apical area an external connection piece which is received by an inner area of the screw-in part, to form a form-locking rotation-safe connection. Such an implant or dental implant is also suitable, in addition to being used in an above-described implant system, for fastening a blocked dental prosthesis, using at least one further such implant, and/or a natural or artificial tooth. Advantageous embodiments of the implant can analogously be deduced from the above-explained embodiments of the mesial implant of the implant system.

In that case, a corresponding implant arrangement or a corresponding implant system consists, for example, of a plurality of such implants. Such an implant arrangement can freely be positioned in the jaw—on condition that the bone offer is sufficient. When anchoring a blocked dental prosthesis by such an implant and a natural/artificial tooth, or by an implant arrangement with at least two of these implants—possibly in combination with a natural/artificial tooth—the forces resulting from biting and chewing movements can be transmitted into the jaw in a manner sparing the material.

The advantages of the invention consist in particular in that a multi-piece version of the abutment of the respective mesial implant in the front area of the jaw opens up possibilities of purposefully compensating stresses and forces arising in this area of the jaw, such as, for example, lateral shearing forces, static frictional forces, abrasive actions, loosening, tensile forces and micromovements. In particular in a two-piece embodiment of the abutment, this functionality can be provided, on the one hand, and, on the other hand, the number of elements or components is increased very slightly only as compared with the single-piece construction.

An advantageous distribution of forces can be realized in particular by means of a construction with an insertion part which can be inserted or plugged into the screw-in part of the implant and a screw-in pillar which can be inserted into the insertion part and can be screwed together with the screw-in part. By means of a guide cylinder following a head area of the screw-in pillar (and a conical centering bearing face following the guide cylinder), lateral shearing forces, which might arise through chewing and biting processes, can be compensated. A form-locking connection with an internal hexagon in the screw-in part and an external hexagon in the insertion part creates a torsion-safe connection between these two components.

An exemplary embodiment of the invention is explained in detail by means of a drawing, in which, in a strongly schematized representation,

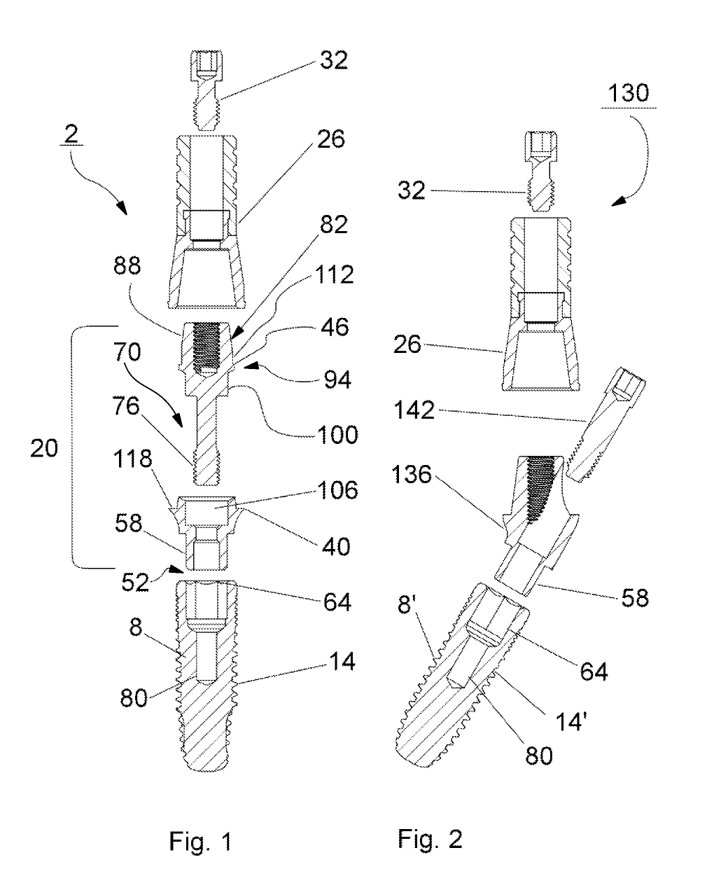

FIG. 1 is a cross-section of a mesial implant of an implant system in a preferred embodiment, having a functional part, a screw-in part, and a two-piece abutment,

FIG. 2 is a cross-section of a distal implant of an implant system in a preferred embodiment, having a functional part, a screw-in part and a single-piece abutment,

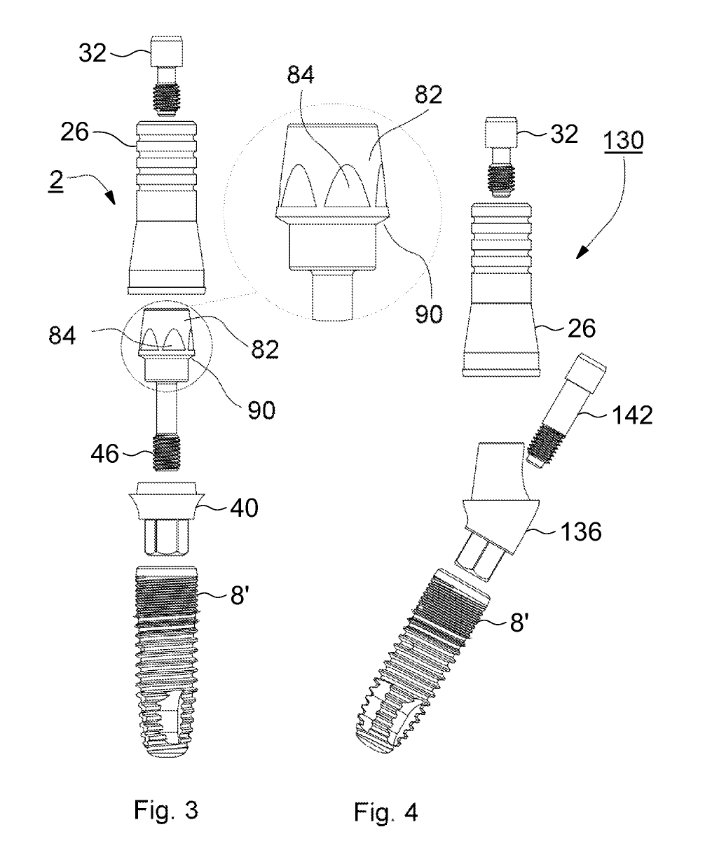

FIG. 3 is a perspective view of the mesial implant of FIG. 1,

FIG. 4 is a perspective view of the distal implant of FIG. 2,

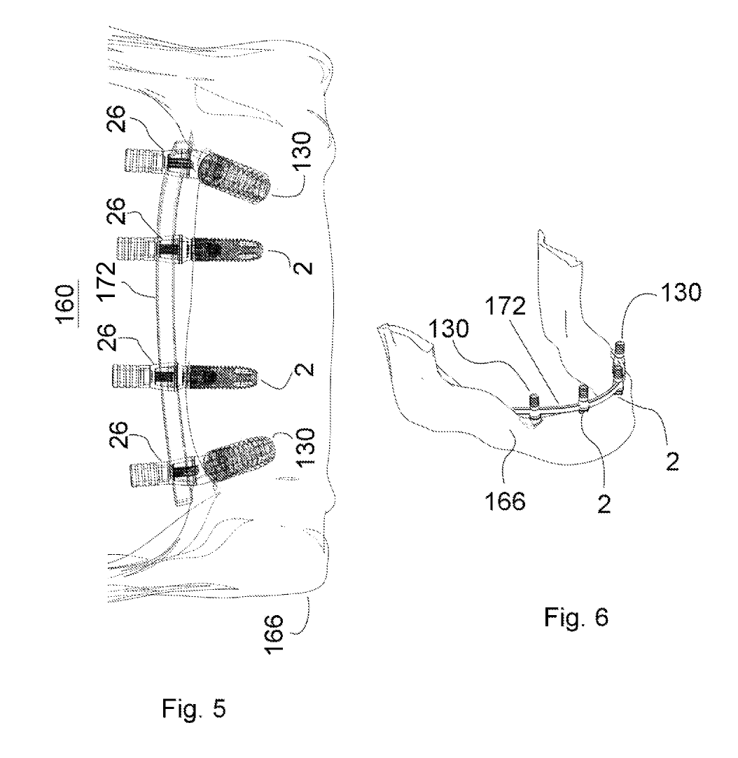

FIG. 5 is a front view of a human lower jaw, in which an implant system with two implants according to FIG. 1 and two implants according to FIG. 2 is inserted, which carries a bridge, and

FIG. 6 is a perspective view of the human lower jaw with the inserted implant system of FIG. 5.

Identical parts are marked with the same reference numbers in all figures.

An implant 2 or dental implant for use in the front or mesial area of the jaw, or in the area of the incisors, a cross-section of which is shown in FIG. 1, comprises a screw-in part 8, which is provided with an external thread 14 for being screwed into the patient's jaw bone. The mesial implant 2, which can also be called anterior implant, comprises, furthermore, an abutment 20 as well as a functional part 26 which can be screwed together with the abutment 20 by means of a functional screw 32. The functional part 26 serves for anchoring an artificial dental prosthesis, for example a bridge, in the patient's jaw.

The abutment 20 is made up of two parts, namely an insertion part 40 or plug-in part and a screw-in pillar 46 which can be inserted into the insertion part 40 and screwed together with the screw-in part 8. This two-piece design of the abutment 20 allows in an optimized manner the absorption of forces arising when loading dental prostheses anchored on four or more implants. The insertion part 40 includes in an apical area 52 an external hexagon 58, i.e. an area with a hexagonal shape on the outside, which forms a form-locking and torsion-safe connection with an internal hexagon 64, i.e. an area with a hexagonal shape on the inside, provided in the screw-in part 8, in the inserted or plugged-in condition. Due to the two-piece construction of the abutment 20, the implant 2 is made up of four parts, namely the screw-in part 8, the insertion part 40, the screw-in pillar 46, and the functional part 26.

In an apical end area 70 or at an apical end, the screw-in pillar 46 has an external thread 76, which can be screwed into a corresponding internal thread 80 of the screw-in part 8. In the screwed-in condition, the insertion part 40 is locked between the screw-in part 8 and a head area 82 of the screw-in pillar 46. A conically aligned attachment 88 is provided in the head area 82 for receiving the functional part 26. A guide cylinder 100 is provided at an apical end 94 of the head area 82, adjacent to the conically aligned attachment 88. In the inserted condition, this guide cylinder 100 forms a form-locking connection with a cylindrical inner area 106 of the insertion part 40. For additional stabilization, the head area 82 of the screw-in pillar 46 includes a protruding annular area 112, which in the assembled condition rests on an annular projection 118 of the insertion part 40.

With these embodiments, (lateral) shearing forces as well as compressive and tensile forces, caused in particular through the spatial extension of the artificial dental prosthesis held by the implant system, for example a bridge, can be compensated. The biting forces load the artificial dental prosthesis mainly for pressure, the compressive forces being lower in the anterior area than in the posterior area, for biomechanical reasons. Due to the natural grinding movement, additional shearing forces superimpose the compressive forces. Thus, the amount and orientation of the resulting total force are dynamical.

A typical dental prosthesis or the corresponding implant system on which the invention is based includes in the distal area a bridge extension in the distal direction as a free end. This extends the reconstruction and thus, also the chewing zone, towards the posterior area. Due to the leverage ratios, tensile forces acting upon the mesial implants will develop in this load case. The axis of rotation runs in this case through the distal implants. The forces are introduced through the osseous connection of the implants (here: screw-in parts) with the jaw bone.

It is a constructional target of the invention to minimize the micromovements in all block interfaces, unloading the screw-in joints as far as possible through largedimensioned and form-locking guiding and/or bearing faces.

FIG. 2 shows an implant 130, which is inserted as a posterior or distal implant in the distal area of the patient's jaw. The functional screw 32 and the functional part 26 are identical with those of the implant 2, so that it is not necessary to manufacture different components for the two implant types 2, 130. The implant 130 includes a screw-in part 8′ with an external thread 14′. The screw-in part 8′ with the external thread 14′ is preferably of the same design as the screw-in part 8 with the external thread 14 of the mesial implant 2.

The abutment 136 of the implant 130 is bent by an angle of 30°, so that—with an orientation of the functional part 26 which is substantially identical with that of the functional part of the respective implant 2 in the jaw—the screw-in part 8′ can be inserted obliquely into the patient's jaw. The single-piece abutment 136 is connected with the screw-in part 8′ by screwing it together therewith, with a screw 142. The abutment 136 has—like the abutment 20—an external hexagon 58 forming in the screwed-in condition a form-locking connection with an internal hexagon 64 of the screw-in part 8′.

FIGS. 3 and 4 are each perspective views in the manner of exploded views of the implants 2, 130. FIG. 3 shows in addition an enlarged view of the head area 82 of the implant 2. The head area 82 includes at its outer end an external hexagon 84, via which the screw-in pillar 46 can be screwed into the screw-in part 8 using a suitable tool. Instead of an external hexagon 84, another external profile can also be chosen—depending on the chosen tool—for docking a suitable screw-in tool.

FIG. 5 is a front view of a preferred embodiment of an implant system 160. In this case, the implant system 160 is inserted in a patient's lower jaw 166. The implant system 160 comprises exactly two mesial implants 2 and two distal implants 130. A schematically shown bridge 172 is fastened in the known manner on the respective functional parts 36. Here, various solutions are possible from the point of view of dental engineering, such as milled CAD-CAM bridges or bars, or soldered or molded bridges or bars.

FIG. 6 is a perspective view of the lower jaw 166 of FIG. 5. One recognizes the two mesial implants 2 and the two distal implants 130 as well as the bridge 172. If the bridge 172 shall extend even farther towards the rear area of the lower jaw 166, two additional distal implants can be provided, so that then, a total of two mesial and four distal implants would be used. The implant system is equally suitable for use in the upper jaw and in the lower jaw.

1. An implant system (160) for fastening a blocked, detachable dental prosthesis (172) in a patient's jaw (166), comprising at least one distal implant (130) and at least one mesial implant (2), wherein each implant (2, 130) comprises a screw-in part (8) with an external thread (14), an abutment (20, 136) which can be inserted into the screw-in part (8), and a functional part (26) for receiving the dental prosthesis (172), which can be screwed together with the abutment (20, 136) by means of a functional screw (32), wherein the abutment (20) of each mesial implant (2) is made up of several parts, in particular of two parts.

2. The implant system (160) of claim 1, wherein the abutment (20) of the mesial implant (2) is made up of two parts, namely of an insertion part (40) which can be inserted into the screw-in part (8) and a screw-in pillar (46) which can be inserted into the insertion part (40).

3. The implant system (160) of claim 2, wherein the insertion part (40) includes in an apical area (52) an external connection piece which is received by an inner area of the screw-in part (8), to form a form-locking rotation-safe connection.

4. The implant system (160) of claim 2 or 3, wherein the screw-in part (8) includes an internal thread (80) and the screw-in pillar (46) includes in an apical end area (70) a matching external thread (76), so that the screw-in pillar (46) can be screwed into the screw-in part (8).

5. The implant system (160) of any of claims 2 to 4, wherein the screw-in pillar (46) includes in a coronal head area (82) a conically aligned attachment (88) for receiving the functional part (26).

6. The implant system (160) of claim 5, wherein a guide cylinder (100), in particular a guide cylinder with a conical bearing seat (90), follows an apical end (94) of the head area (82), said guide cylinder (100) being received, in the inserted condition, by the insertion part (40) in a form-locking manner.

7. The implant system (160) of claim 5 or 6, wherein the conically aligned attachment (88), in the screwed condition of the screw-in pillar (46) and the screw-in part (8), rests on the insertion part (40).

8. The implant system (160) of any of claims 5 to 7, wherein the screw-in pillar (46) includes an external hexagon (84) at the outermost end of the head area (82).

9. The implant system (160) of any of claims 1 to 8, wherein the functional parts (26) of the respective distal implant (130) and mesial implant (2) are of identical configuration.

10. The implant system (160) of any of claims 1 to 9, wherein the functional screws (32) for screwing the functional parts (26) together with the abutments (20) of the distal implant (130) and mesial implant (2) are of identical configuration.

11. The implant system (160) of any of claims 1 to 10, wherein the abutment (136) of the respective distal implant (130) is beveled at an angle between 20° and 40°, in particular of 22° or 35°.

12. The implant system (160) of any of claims 1 to 11 with exactly two distal implants (130) and exactly two mesial implants (2).

13. The implant system (160) of any of claims 1 to 11 with exactly two distal implants (130) and exactly four mesial implants (2).

14. An implant (2), in particular for use as a mesial implant in an implant system of any of claims 1 to 13, comprising a screw-in part (8) with an external thread (14), an abutment (20) which can be inserted into the screw-in part (8), and a functional part (26) for receiving the dental prosthesis (172), which can be screwed together with the abutment (20) by means of a functional screw (32), wherein the abutment (20) is made up of two parts, namely of an insertion part (40) which can be inserted into the screw-in part (8) and a screw-in pillar (46) which can be inserted into in the insertion part (40).

15. The implant (2) of claim 14, wherein the insertion part (40) includes in an apical area (52) an external connection piece which is received by an inner area of the screw-in part (8), to form a form-locking rotation-safe connection.
